(19) United States
(12) Patent Application Publication
(10) Pub. No.: US 2021/0116104 A1
(43) Pub. Date: Apr. 22, 2021

(54) SAFE ZONE INDICATOR DEVICE

(71) Applicant: Omer Barnes, Harrington Park, NJ (US)

(72) Inventor: Omer Barnes, Harrington Park, NJ (US)

(21) Appl. No.: 17/072,960

(22) Filed: Oct. 16, 2020

Related U.S. Application Data
(60) Provisional application No. 62/915,757, filed on Oct. 16, 2019.

(51) Int. Cl. F21V 14/02; F21S 8/00

(52) U.S. Cl. CPC F21V 14/02; F21W 2111/00; F21S 8/033

(57) ABSTRACT

A light projecting device mountable to a wall such as a classroom wall. The projecting device has one or more light sources that are configured to project a light beam on floor surface, ceiling surface, or both. The light sources are adjustable to project the beam at an angle with respect to the wall. The projected beam demarcates an area that is within gunfire range and an area that is safe from gunfire.

### RELATED APPLICATIONS

This application claims the benefit of pending U.S. Prov. Appl. 62/915,757 filed Oct. 16, 2019, the contents of which are incorporated by reference herein.

### FIELD OF THE INVENTION

The invention relates to the field of emergency signal systems, more specifically to a device for demarcating a safe zone within a room during a lock down incident.

### BACKGROUND OF THE INVENTION

Incidents of mass shootings have, unfortunately, been on the rise across the United States. In response, schools and other public institutions have invested in physical security enhancements and they have instituted safety plans, such as lock down procedures, to enhance preparedness for a live shooting event.

As part of such lock down procedures, students and teachers are told to move to a classroom area that is not in line with the door, just in case shots are fired through the classroom door. However, there is not a clear indication of where a “safe zone” is demarcated within the classroom. This may lead to increased confusion and tension during a drill or a live shooting event.

### SUMMARY OF THE INVENTION

Embodiments of the invention provide for a system that automatically applies a line of demarcation during a lock down event that clearly identifies an area within a room that is deemed to be a “safe zone.”

### BRIEF DESCRIPTION OF THE DRAWINGS

FIG. 1 is a side perspective view of a beam projector in accordance with an exemplary embodiment of the invention.

FIG. 2 is a schematic top view of a room configuration showing a beam projector projecting a beam in accordance with an embodiment of the invention.

FIG. 3 is a side perspective view of a beam projector device in accordance with an exemplary embodiment of the invention.

### DETAILED DESCRIPTION OF THE INVENTION

Embodiments of the present invention will now be described with reference to the above-identified figures. However, the drawings and the description herein of the invention are not intended to limit the scope of the invention. It will be understood that various modifications of the present description of the invention are possible without departing from the spirit of the invention. Also, features or steps described herein may be omitted, additional steps or features may be included, and/or features or steps described herein may be combined in a manner different from the specific combinations recited herein without departing from the spirit of the invention, all as understood by those of skill in the art.

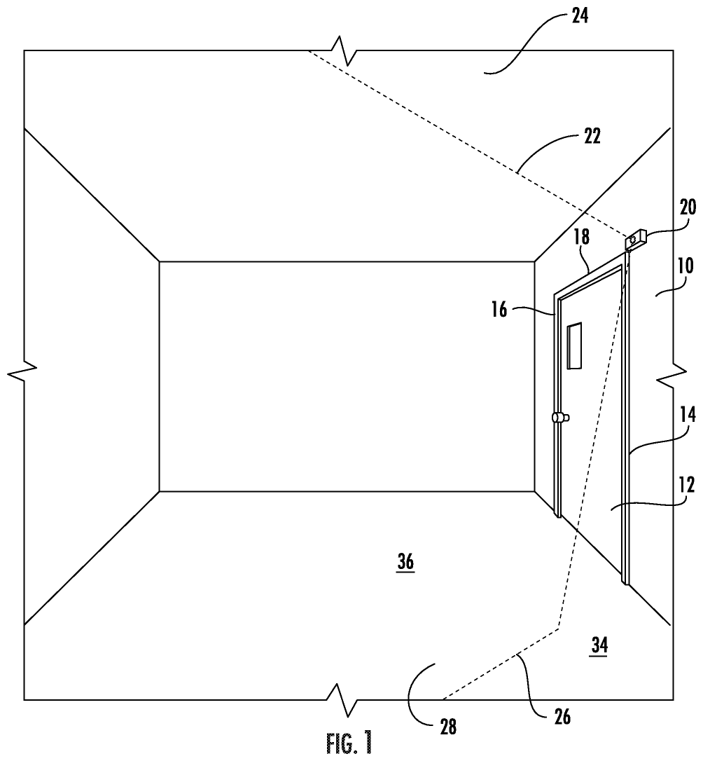

As set forth, embodiments of the invention relate to a device for emitting a temporary light beam in order to demarcate a safe zone during a lock down incident. With reference to FIG. 1, a segment of an inside wall 10 of a room is shown. A door 12 positioned toward the front of the room is shown in a closed position. A door frame is formed of a first vertical door frame member 14 (positioned closer to the rear of the room), a second vertical door frame member 16 (positioned closer to the front of the room), and a bridging upper horizontal door frame 18.

A beam projector device 20 is mounted on wall 10, substantially above the door frame member 14 which faces the rear of the room. The beam projector contains a light emitting device such as a light bulb or LED focused through an optical system, a laser beam projector or such similar collimated light source.

In an embodiment of the invention, the beam projector is configured to project at least a single light beam toward the rear of the room. For example, in embodiments of the invention, the device is configured to project a beam 22 is on the ceiling 24. In other embodiments, the beam 26 is projected on the floor 28. Still in other embodiments, and as shown in FIG. 1, beams 22, 26 are simultaneously projected on the ceiling 24 and floor 28. It will be understood that device 20 may contain one or more beam projectors each configured to project a collimated or focused light source. For example, in embodiments of the invention, a first beam projector is directed downward and configured to project a light beam on a floor surface, whereas, a second beam projector is directed upward and configured to project a light beam on a ceiling surface.

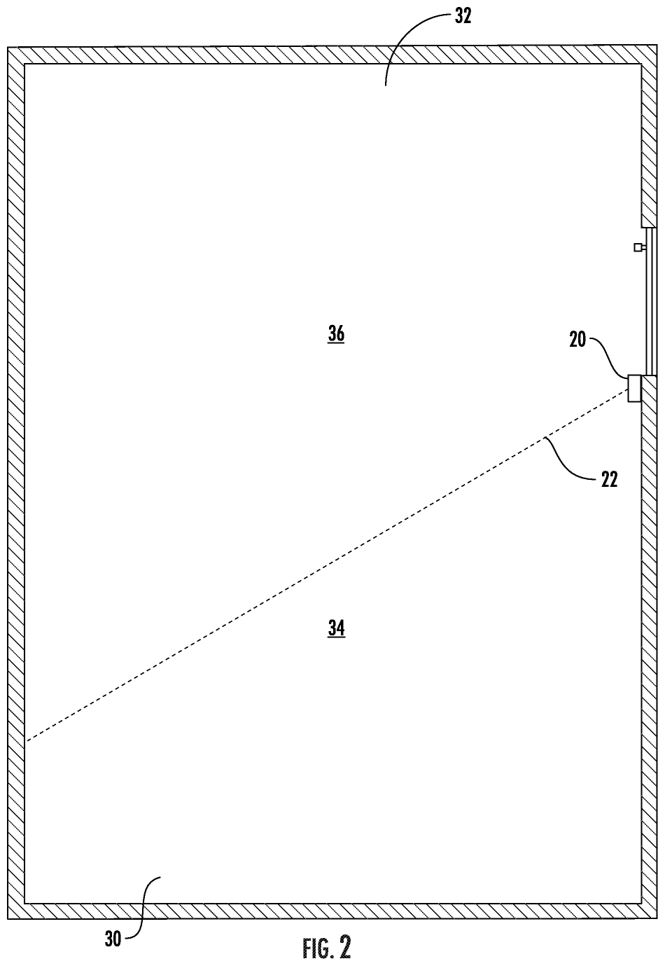

The angle (with respect to wall 10) at which beams 22, 26 are projected is calibrated to correspond to the angle that gunfire may travel if shots are fired through the door. For example, referring to FIG. 2, which shows a top cross-sectional view of the room of FIG. 1, light beam 22 is shown directed toward the rear 30 of the room. Beam 22 forms a first, obtuse angle (with respect to wall 10) between the beam 22 and the front of the room 32 and a second, acute angle between the beam 22 and rear 30 of the room.

The area 34 marked by the second angle is a “safe zone,” namely, a zone that is not reachable by gunfire, whereas, area 36 is a danger zone during a live gunfire event.

In embodiments of the invention, the beam projector device 20 is hard-wired to an electrical power source, whereas in other embodiments, the beam projector device 20 is powered by a battery. Still in other embodiments, the device 20 is powered by an electric power source and is also provided with one or more backup batteries.

In embodiments of the invention, in addition to displaying the demarcating light beams, the word “LOCKDOWN” may be projected on a wall, ceiling and/or floor of a room.

In embodiments of the invention, the beam projector device 20 is connected to a central source (e.g. computer or hard drive) via, hardwire or a wireless protocol such as, for example, WiFi or Bluetooth. In embodiments of the invention, the beam projector device 20 is controlled by hard-wired micro switch.

In embodiments of the invention, a series of beam projector devices are connected via network. In embodiments of the invention, a central computer is configured to communicate with the each of the beam projector device when a lock down event is triggered. For example, the central computer transmits an instruction to beam projector devices in a given building or in a given area or zone to go into “lock down” mode. In this mode, the demarcation beams are activated as well as other optional features associated with the beam projectors devices.

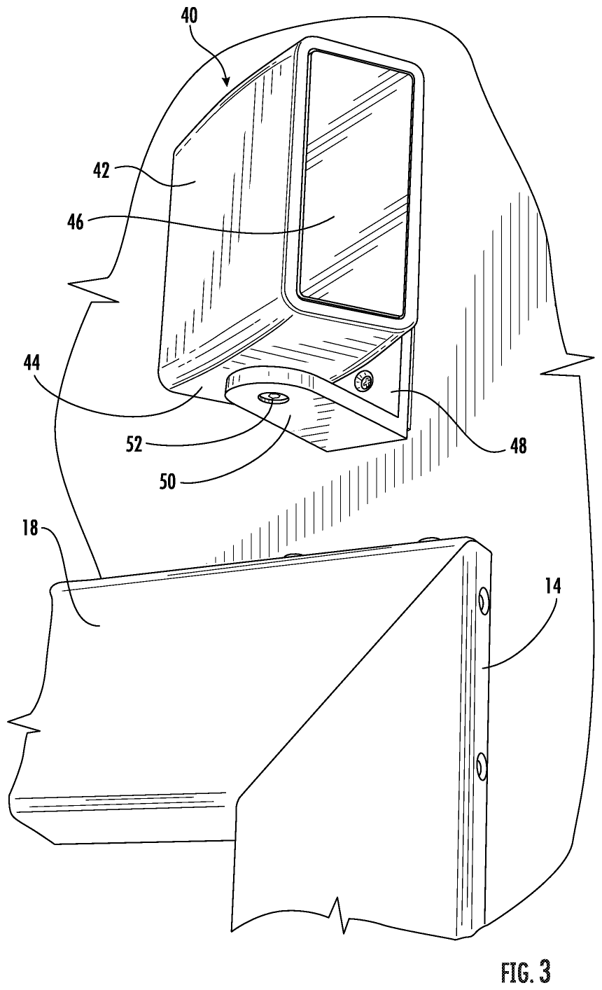

FIG. 3 shows a beam projector device 40 in accordance with an embodiment of the invention. As shown, projector device 40 is formed of a housing have a left sidewall 42, a right sidewall, an upper wall, a lower wall 44 and a rear wall. Front of the device 40 is provided with a window 46 or similar surface that allows for the projection of beams from light emitting devise contained within the housing.

Projector devices in accordance with embodiments of the invention are provided with mounting hardware for mounting the device to a wall area above a door or to a door frame. For example, with a reference to FIG. 3, a cooperating bracket is show that is used to mount the device 40 to a wall. In embodiments of the invention a substantially “U-shaped” bracket is used formed of an elongated member 48 configured to align with a wall surface and an upper and lower arm segments (only lower arm segment 50 shown in FIG. 3) that extend at substantial right angles from elongated member 48. Device 40 is pivotably mounted to the bracket by way of a pivot or an axle. For example, as shown in FIG. 3, a pin 52 extending from lower wall 44 of the device inserts into a hole in lower bracket arm 50 (and the same for the upper surface, not shown). In such configuration, device 40 is pivotable by a user to align the light source in accordance with a desired trajectory.

It will be understood by those of ordinary skill in the art that any of various features may be integrated into the beam projector in embodiments of the invention. For example, the projector devices may include integrated wide-angle cameras and a microphone that capture views of substantially the entire room in which it is deployed. Images and audio captured by the device may be streamed in real time to a central location and/or stored on a hard drive for future retrieval. In embodiments, a memory card or similar digital recording medium automatically begins storing audio/video once the camera and/or microphone is activated. The projector may also include a microphone and speaker. The microphone/speaker may be independently operated or integrated with a central PA system.

In embodiments of the invention, the projector is provided with a backup LED light that may be used in the event of power loss and it also may include an illuminated exit sign.

It will be understood that the projectors of the invention may be linked to an app whereby third parties may interface with the projector device.

Embodiments of the invention provide a method for visually demarcating a zone or section within a room that is safe from gunfire. The method includes mounting a beam projector substantially at the most extreme angle of a possible trajectory of gunfire and projecting a beam along such trajectory to clearly mark which area is within reach of gunfire and which area is shielded therefrom.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A beam projector, comprising:
a housing that is mountable to a wall surface;
a light source disposed within the housing configured to project a light beam at a floor surface;
the light source being movable to project the light beam at any of a plurality of angles with respect to the wall;
whereby a first area of the floor surface demarcated by the light beam comprises an unsafe zone and a second area of the floor surface demarcated by the light beam comprises a safe zone.

2) The beam projector of claim 1, comprising at least two light sources.

3) The beam projector of claim 2, comprising alight source configured to project alight beam on a ceiling.
